(19) United States
(12) Patent Application Publication
(10) Pub. No.: US 2021/0291372 A1
(43) Pub. Date: Sep. 23, 2021

(54) RECYCLING ROBOT

(71) Applicant: TECO Electric & Machinery Co., Ltd., Taipei City (TW)

(72) Inventors: Chia-Jen LIN, Taipei City (TW); Cheng-Yun CHUNG, Taipei City (TW); Shih-Chang CHEU, Taipei City (TW); Chun Chi LAI, Taipei City (TW)

(21) Appl. No.: 16/869,095

(22) Filed: May 7, 2020

(30) Foreign Application Priority Data
Mar. 18, 2020 (TW) 109108882

(51) Int. Cl. B25J 9/16

(52) U.S. Cl. CPC B25J 9/1679; B25J 5/007; B25J 9/1664

(57) ABSTRACT

A recycling robot, applied to recycle a plurality of trays while in moving along a working path, includes a map module, a carrier assembly, a switch module and a control module. The map module is to store a work-area map having the working path and a plurality of tray-collecting areas. The carrier assembly is used for carrying the plurality of trays. The switch module, furnished with respect to the carrier assembly, is used for moving the carrier assembly in a gravity direction toward a signal-generating position and then transmitting a full-load signal upon when a bearing weight of the carrier assembly reaches a maximum load capacity. The control module, communicatively connected with the switch module, is used for controlling the recycling robot to move away from the working path and to approach one of the plurality of tray-collecting areas upon when the full-load signal is received.

This application claims the benefit of Taiwan Patent Application Serial No.109108882, filed Mar. 18, 2020, the subject matter of which is incorporated herein by reference.

### BACKGROUND OF THE INVENTION

### (1) Field of the Invention

The invention relates to a robot, and more particularly to a recycling robot.

### (2) Description of the Prior Art

Nowadays, food streets or dining areas are widely seen in department stores, national highway rest stations, shopping malls or even hospitals.

In these food streets or dining areas, successful used tray collection does highly rely on user ethics or additional collecting staff. In particular, to a popular dining area usually surrounded by versatile cafeteria, collecting or recycling used food trays is a labor and time-consuming task. Furthermore, after the food trays are collected, sorting and further processing are still required. In the case that the number of staff is limited in the dining, then individual work load thereto would be huge. On the other hand, in the case that human power is excessive there, then the labor cost might be too high to be contained. Nevertheless, if the collection or recycle of the used food trays depends only by the users themselves, the dining area may be a mess if existing too many lazy people. Therefore, current collection or recycle of the food trays in the dining area does need improvement.

### SUMMARY OF THE INVENTION

In view that the conventional dining area exists some labor, cost and cleanliness problems associated with the recycling work of the used food trays, accordingly it is an object of the present invention to provide a recycling robot used for resolving at least one of the aforesaid problems.

In this invention, a recycling robot, applied to recycle a plurality of trays while in moving along a working path, includes a map module, a carrier assembly, a switch module and a control module. The map module is to store a work-area map having the working path and a plurality of tray-collecting areas. The carrier assembly is used for carrying the plurality of trays. The switch module, furnished with respect to the carrier assembly, is used for moving the carrier assembly in a gravity direction toward a signal-generating position and then transmitting a full-load signal upon when a bearing weight of the carrier assembly reaches a maximum load capacity. The control module, communicatively connected with the switch module, is used for controlling the recycling robot to move away from the working path and to approach one of the plurality of tray-collecting areas upon when the full-load signal is received.

In one embodiment of the present invention, the recycling robot, further includes a speaker module. The speaker module is communicatively connected with the control module and the switch module, and used for broadcasting a recycle audio while the recycling robot moves along the working path and a full-load audio upon when the full-load signal is received.

In one embodiment of the present invention, the control module includes a collecting-point setting unit and a collecting-point controlling unit. The collecting-point setting unit is used for defining a plurality of collecting points along the working path. The collecting-point controlling unit, communicatively connected with the collecting-point setting unit, is used for controlling the recycling robot to stop temporarily for a preset time at each of the plurality of collecting points.

In one embodiment of the present invention, the recycling robot further includes a clock module communicatively connected with the collecting-point controlling unit, used for counting the preset time.

In one embodiment of the present invention, the control module includes a terminating-point setting unit and a terminating-point controlling unit. The terminating-point setting unit is used for defining a terminating point upon when the recycling robot stop to follow the working path. The terminating-point controlling unit, communicatively connected with the terminating-point setting unit, is used for controlling the recycling robot to move back to the terminating point after the plurality of trays is removed from the recycling robot.

In one embodiment of the present invention, the control module includes a distance-calculating unit, and the distance-calculating unit is used for calculating a distance between an instant position of the recycling robot and each of the plurality of tray-collecting areas upon when the full-load signal is received, and for controlling the recycling robot to move to one of the plurality of tray-collecting areas that has the minimum distance from the instant position.

In one embodiment of the present invention, the control module includes a direction-detecting unit, and the direction-detecting unit is used for detecting a moving direction for the recycling robot to follow the working path, and also for providing controls for moving the recycling robot along the work path to one of the plurality of tray-collecting areas that is the closest to the recycling robot.

In one embodiment of the present invention, the carrier assembly includes at least one carrier rack.

As stated, the recycling robot provided by the present invention is used for collecting the used trays while in moving along the working path, and for moving to one of the tray-collecting areas upon when the full-load state of the carrier assembly is determined. Thereupon, the shortcoming in the art that people are needed to collect the trays table by table can be effectively resolved. In addition, since the recycling robot could be fresh to the customers, thus a motivation of feeding the recycling robot with the trays may be arisen in most of the customers, and from which the cleanliness problem in the dining area can be substantially resolved as well.

All these objects are achieved by the recycling robot described below.

### BRIEF DESCRIPTION OF THE DRAWINGS

The present invention will now be specified with reference to its preferred embodiment illustrated in the drawings, in which:

FIG. 1 is a schematic block view of a preferred embodiment of the recycling robot in accordance with the present invention;

FIG. 2 is a schematic perspective view of the embodiment of FIG. 1;

FIG. 3 demonstrates schematically an application of the embodiment of FIG. 2;

FIG. 4 demonstrates schematically a relative position of the embodiment of FIG. 2 moving along a working path in a work area;

FIG. 5 demonstrates schematically that the embodiment of FIG. 2 stops at a collecting point of FIG. 4;

FIG. 6 demonstrates schematically that the embodiment of FIG. 2 moves to a new collecting point from FIG. 4 along a working path;

FIG. 7 shows schematically a full-load state in the carrier assembly of the embodiment of FIG. 2;

FIG. 8 demonstrates schematically that the embodiment of FIG. 2 moves away from the working path but approaches a tray-collecting area; and

FIG. 9 demonstrates schematically that the embodiment of FIG. 2 arrives the tray-collecting area.

### DESCRIPTION OF THE PREFERRED EMBODIMENT

The invention disclosed herein is directed to a recycling robot. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

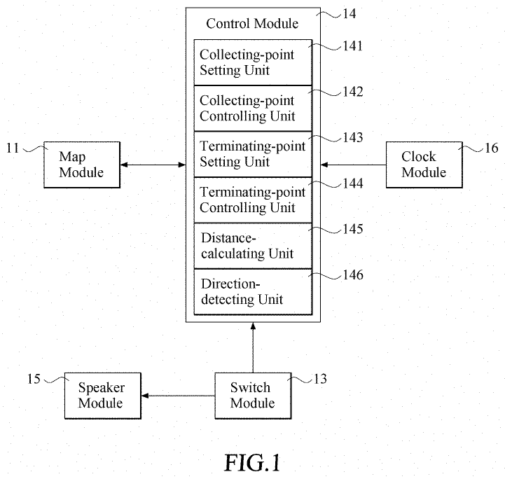

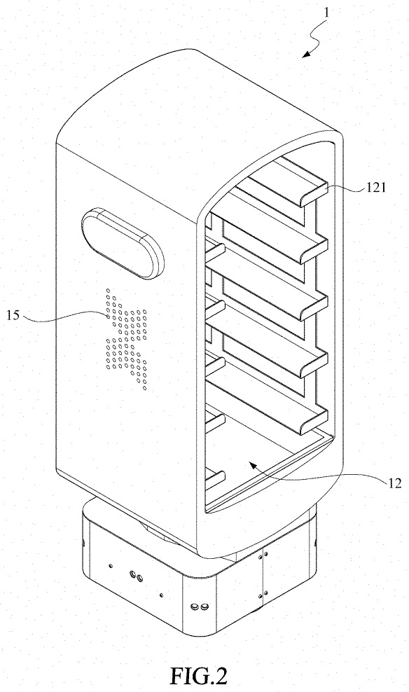

Refer to FIG. 1 and FIG. 2; where FIG. 1 is a schematic block view of a preferred embodiment of the recycling robot in accordance with the present invention, and FIG. 2 is a schematic perspective view of the embodiment of FIG. 1. As shown, the recycling robot 1 includes a map module 11, a carrier assembly 12, a switch module 13, a control module 14, a speaker module 15 and a clock module 16.

The map module 11 stores a work-area map having a working path and a plurality of tray-collecting areas.

The carrier assembly 12 is used for carrying a plurality of trays. In this embodiment, the carrier assembly 12 can include, but not limited to, five carrier racks 121 (only one labeled in the figure).

The switch module 13, furnished with respect to the carrier assembly 12, is used for moving the carrier assembly 12 in a gravity direction toward a signal-generating position, and transmitting a full-load signal, upon when a bearing weight of the carrier assembly 12 reaches a maximum load capacity.

The control module 14, communicatively connected with the switch module 13, is used for controlling the recycling robot 1 to move away from the working path and to approach one of the tray-collecting areas, after the full-load signal is received. In this embodiment, the control module 14 includes a collecting-point setting unit 141, a collecting-point controlling unit 142, a terminating-point setting unit 143, a terminating-point controlling unit 144, a distance-calculating unit 145 and a direction-detecting unit 146.

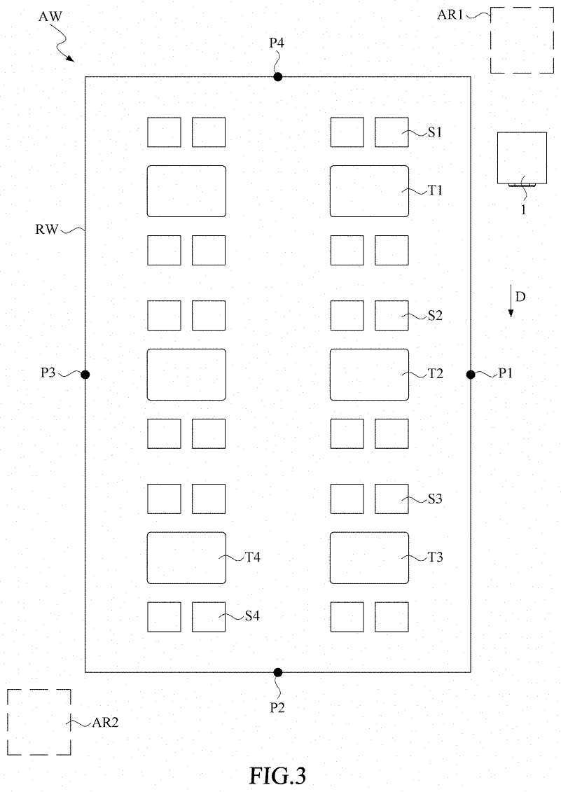

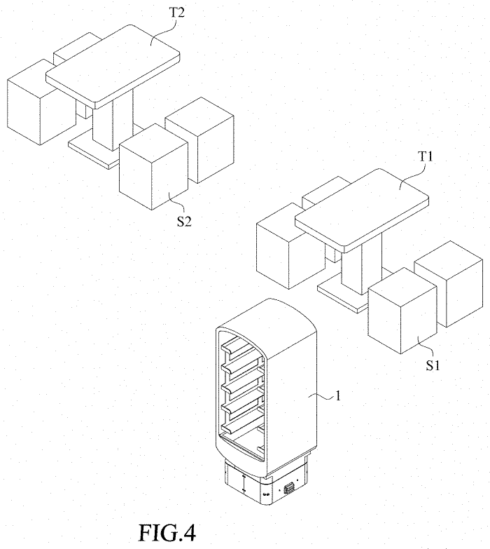

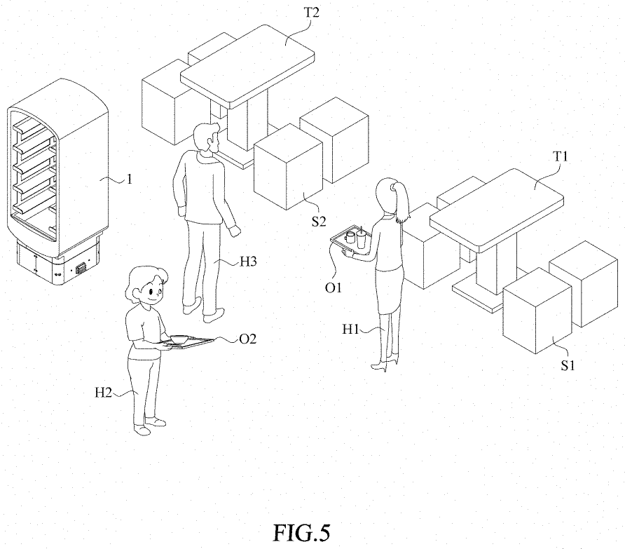

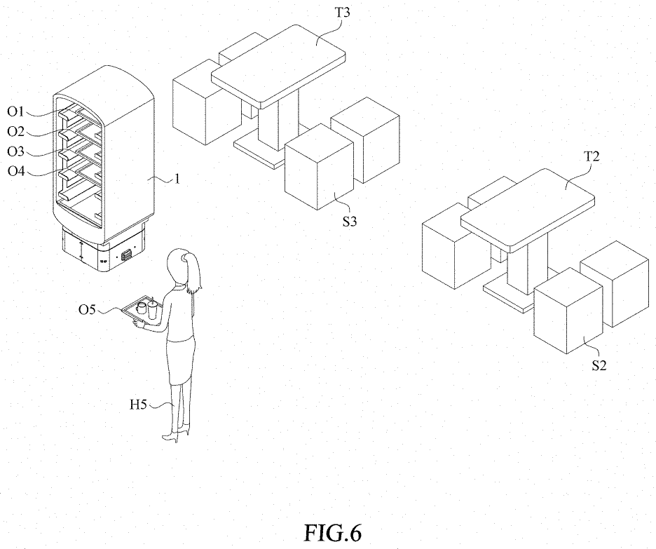

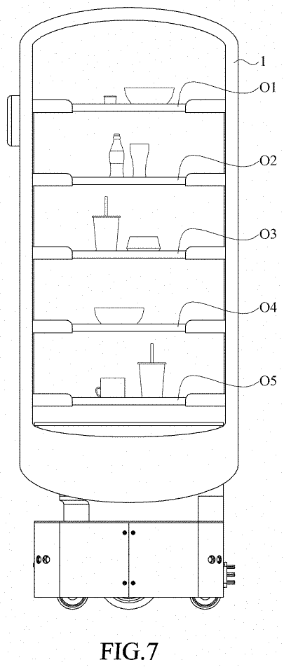

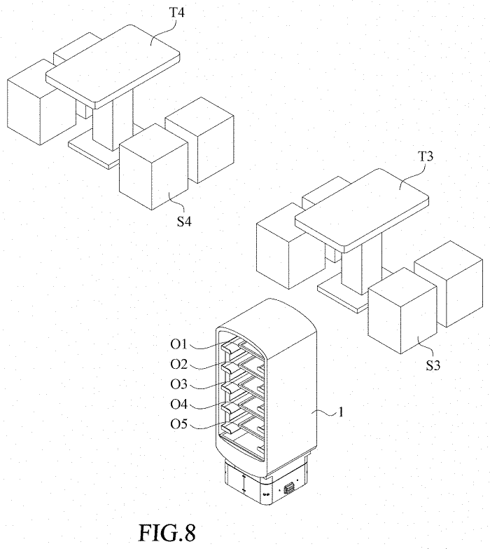

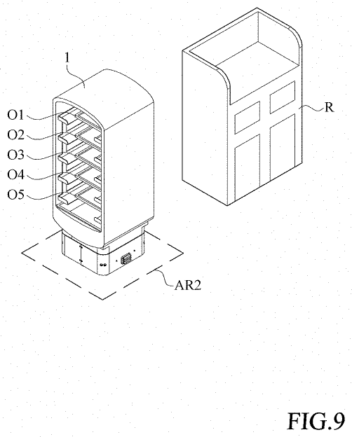

Then, refer to FIG. 1 through FIG. 9; where FIG. 3 demonstrates schematically an application of the embodiment of FIG. 2, FIG. 4 demonstrates schematically a relative position of the embodiment of FIG. 2 moving along a working path in a work area, FIG. 5 demonstrates schematically that the embodiment of FIG. 2 stops at a collecting point of FIG. 4, FIG. 6 demonstrates schematically that the embodiment of FIG. 2 moves to a new collecting point from FIG. 4 along a working path, FIG. 7 shows schematically a full-load state in the carrier assembly of the embodiment of FIG. 2, FIG. 8 demonstrates schematically that the embodiment of FIG. 2 moves away from the working path but approaches a tray-collecting area, and FIG. 9 demonstrates schematically that the embodiment of FIG. 2 arrives the tray-collecting area. As shown, the recycling robot 1 moves along a working path RW in a moving direction D within a work area AW.

It shall be explained that the map module 11 stores work-area maps corresponding to individual work areas AW. The working paths RW is defined with the work-area maps, not on the real work areas AW. However, for concisely elucidating features of the present invention, the working path RW would be depicted directly in the practical work area AW.

The work area AW is built in with a plurality of tables T1, T2, T3, T4, a plurality of chairs S1, S2, S3, S4 and a plurality of tray-collecting areas AR1, AR2.

The collecting-point setting unit 141 would define a plurality of collecting points P1, P2, P3, P4 along the working path RW. Whenever the recycling robot 1 arrives any of the collecting points P1, P2, P3, P4, the collecting-point controlling unit 142 would control the recycling robot 1 to stop temporarily. In particular, at each of the collecting points P1, P2, P3, P4, the recycling robot 1 would stay for a preset time, such as 10 seconds, 15 seconds, or any relevant time duration. The clock module 16, used for counting the preset time, can be a timer, a timing chip, or a firmware or device that provides a clock function.

As shown in FIG. 4 and FIG. 5, the recycling robot 1, following a working path RW passing tables T1, T2, is controlled by the collecting-point controlling unit 142 to stop at the collecting point P1, close to table T2. Then, customers close to the collecting point P1 can return their trays into the carrier assembly 12. In FIG. 5, three customers H1, H2, H3 are shown, in which customers H1 and H2 carry their own trays O1 and O2.

When the counting of the preset time is over, the recycling robot 1 would move further along the working path RW. It shall be noted that, in FIG. 6, the carrier assembly 12 of the recycling robot 1 has been loaded with four trays O1, O2, O3, O4. In this embodiment, the moving speed of the recycling robot 1 along the working path RW is purposely slowed down. Namely, even that the recycling robot 1 is moved along the working path RW, a customer can still put his/her tray into the carrier assembly 12 safely. Referring back to FIG. 3, it is shown that only the collecting point P1 is located to the same side of table T3 and table T2. Thus, as shown in FIG. 6, while the recycling robot 1 in a moving state, not a stop state, is moved close to table T3 with a slower moving speed, then the customer H5 can still approach the moving recycling robot 1 for loading a tray O5 into the carrier assembly 12.

After the tray O5 has been placed into the carrier assembly 12, the switch module 13 would be introduced to determine if or not the carrier assembly 12 is in a full-load state, as shown in FIG. 7. If positive, a full-load signal would be generated and then transmitted forward. In detail, the total weight of the trays O1, O2, O3, O4, O5 carried by the carrier assembly 12 is called as a bearing weight. The bearing weight would drive the carrier assembly 12 downward; i.e., to displace in a gravity direction. When the bearing weight reaches a maximum (i.e., the load capacity of the carrier assembly 12), the carrier assembly 12 would move downward in the gravity direction to reach a signal-generating position, then a full-load signal would be triggered.

Basically, the switch module 13 is to evaluate the total weight of the trays carried by the carrier assembly 12. In practice, the switch module 13 may include a pressure sensor for determine whether or not the bearing weight caused by the trays can lower the carrier assembly 12 enough to trigger the full-load signal.

After the control module 14 receives the full-load signal, the recycling robot 1 would be ordered not to follow the working path RW, but to move toward the tray-collecting area AR1 or AR2.

The distance-calculating unit 145 would calculate a distance between the recycling robot 1 and the tray-collecting area AR1, and another distance between the recycling robot 1 and the tray-collecting area AR2. Preferably, the control module 14 would drive the recycling robot 1 to follow the shortest path to the most nearby tray-collecting area; i.e., the tray-collecting area AR2 in this embodiment.

In addition, the direction-detecting unit 146 would detect the moving direction D for the recycling robot 1 to follow the working path RW. The direction-detecting unit 146 of the control module 14 can provide controls for moving the recycling robot 1 to the most nearby tray-collecting area in the moving direction D; i.e., still the tray-collecting area AR2 in this embodiment.

In applying the distance-calculating unit 145 and the direction-detecting unit 146, different control outcomes may be obtained. For example, in a situation that the recycling robot 1 reaches the full-load state at the collecting point P1, then the recycling robot 1 would be controlled to the tray-collecting area AR1 if the minimum distance calculated by the distance-calculating unit 145 is applied, or the recycling robot 1 would be controlled to the tray-collecting area AR2 if the moving direction D detected by the direction-detecting unit 146 is applied.

If the recycling robot 1 is in the full-load state, it will not stop at, but pass directly, the collecting point. In a meantime, a speaker module 15 would generate a full-load audio to inform the customers not to add more trays. As shown in FIG. 8, the collecting point P2 is located between table T3 and table T4. However, since the recycling robot 1 has reached the full-load state already, it will not stop at the collecting point P2, but move directly to the tray-collecting area AR2. In addition, if the recycling robot 1 is yet to reach the full-load state, the speaker module 15 may generate another recycle audio to inform the customers that space in the carrier assembly 12 is still available for containing another tray.

In this embodiment, the tray-collecting area AR2 has a recycling station R for the recycling robot 1 to remove the trays O1, O2, O3, O4, O5. In practice, after the recycling robot 1 reaches the tray-collecting area AR2, the trays O1, O2, O3, O4, O5 carried along by the recycling robot 1 would be moved manually to the recycling station R. In the recycling station R, only removing and sorting are needed. Thereupon, by providing the recycling robot of this invention, tray collecting is no more a tedious table-by-table human job, and work relying on human power can be significantly reduced.

In this embodiment, as the full-load signal is generated, the terminating-point setting unit 143 would define a corresponding terminating point. After the trays O1, O2, O3, O4, O5 are removed from the recycling robot 1, the terminating-point controlling unit 144 would control the recycling robot 1 back to the terminating point, where the full-load state is achieved, for continuing the moving along the working path RW. With this arrangement, the recycling robot 1 can complete the working path RW so as to effectively collect the trays. In other words, no trays would be missed even that the full-load state might be satisfied in the midst of the working path RW.

In summary, the recycling robot provided by this invention applies the map module, the carrier assembly, the switch module and the control module to collect the trays along the working path, and moves to the tray-collecting area right after the switch module transmits the full-load signal. Upon such an arrangement, human work load can be substantially reduced. In addition, with the fancy robot in the dining area, a motivation of feeding the recycling robot with the trays may be arisen in most of the customers. In comparison with the prior art, this invention can greatly reduce human load, improve recycling of the trays, and thus resolve the cleanliness problem at least in the dining area.

While the present invention has been particularly shown and described with reference to a preferred embodiment, it will be understood by those skilled in the art that various changes in form and detail may be without departing from the spirit and scope of the present invention.

What is claimed is:

1. A recycling robot, applied to recycle a plurality of trays while in moving along a working path, comprising:
a map module, storing a work-area map having the working path and a plurality of tray-collecting areas;
a carrier assembly, used for carrying the plurality of trays;
a switch module, furnished with respect to the carrier assembly, used for moving the carrier assembly in a gravity direction toward a signal-generating position and then transmitting a full-load signal upon when a bearing weight of the carrier assembly reaches a maximum load capacity; and
a control module, communicatively connected with the switch module, used for controlling the recycling robot to move away from the working path and to approach one of the plurality of tray-collecting areas upon when the full-load signal is received.

2. The recycling robot of claim 1, further including a speaker module, wherein the speaker module is communicatively connected with the control module and the switch module, and used for broadcasting a recycle audio while the recycling robot moves along the working path and a full-load audio upon when the full-load signal is received.

3. The recycling robot of claim 1, wherein the control module includes:
a collecting-point setting unit, used for defining a plurality of collecting points along the working path; and
a collecting-point controlling unit, communicatively connected with the collecting-point setting unit, used for controlling the recycling robot to stop temporarily for a preset time at each of the plurality of collecting points.

4. The recycling robot of claim 3, further including a clock module, communicatively connected with the collecting-point controlling unit, used for counting the preset time.

5. The recycling robot of claim 1, wherein the control module includes:
a terminating-point setting unit, used for defining a terminating point upon when the recycling robot stop to follow the working path; and
a terminating-point controlling unit, communicatively connected with the terminating-point setting unit, used for controlling the recycling robot to move back to the terminating point after the plurality of trays is removed from the recycling robot.

6. The recycling robot of claim 1, wherein the control module includes a distance-calculating unit, and the distance-calculating unit is used for calculating a distance between an instant position of the recycling robot and each of the plurality of tray-collecting areas upon when the full-load signal is received, and for controlling the recycling robot to move to one of the plurality of tray-collecting areas that has the minimum distance from the instant position.

7. The recycling robot of claim 1, wherein the control module includes a direction-detecting unit, and the direction-detecting unit is used for detecting a moving direction for the recycling robot to follow the working path, and also for controlling the recycling robot to move along the work path to one of the plurality of tray-collecting areas that is the closest to the recycling robot.

8. The recycling robot of claim 1, wherein the carrier assembly includes at least one carrier rack.
